(19) United States
(12) Patent Application Publication
(10) Pub. No.: US 2010/0049563 A1
(43) Pub. Date: Feb. 25, 2010

(54) Interactive Computer Implemented Website System and Its Method of Use

(76) Inventor: Gabriel Lopez Seco, Miami, FL (US)

Correspondence Address: RUBEN ALCOBA, ESQ., 3399 NW 72 AVENUE, SUITE211, MIAMI, FL, 33122, US

(21) Appl. No.: 12/197,019

(22) Filed: Aug. 22, 2008

(51) Int. Cl. G06Q 30/00; G06Q 50/00; G06Q 20/00; G06Q 10/00

(52) U.S. Cl. 705/7; 705/27; 705/40; 705/14.69

(57) ABSTRACT

A website system that allows customers and service providers to enter into secured service agreements, wherein disputes are resolved by the website system without having to resort to the courts, attorneys, or private mediation or arbitration services.

### BACKGROUND

The present invention is related to a website system that allows customers and service providers to enter into secured service agreements, wherein disputes are resolved by the website system without having to resort to the courts, attorneys, or private mediation or arbitration services.

The inventor of the present invention decided to invent the present system after speaking to many friends and service providers. He realized that often, customers are forced to choose service providers without having any knowledge of the quality of work that the service providers provide. In fact, frequently customers have to pay for services at a full price, even though services are less than what they were originally bargained for.

When dealing with the construction industry, this becomes even more magnified. For usually, contractors only have to pass county inspections to be owed money, even though jobs contracted for may have called for more than simple county compliance. The problem with this scenario is that customers may not be able to get satisfaction from service providers without risking liens being placed on their houses. If a lien is placed on a house, the courts will eventually get involved, attorneys will have to be hired, and the party having the best lawyers shall usually be rewarded.

In a world where both parties have the same resources to pay for attorneys, the system is well balanced. The problem is that usually, service providers are well represented, know the system, and realize that the customers usually are not going to hire lawyers to dispute jobs that have been completed, yet are less that what were bargained for.

The inventor also realized that he had to motivate the service industry to buy into his system. Obviously, unscrupulous service providers would not be interested in a website system that would only guarantee them payment upon work being satisfactorily completed. He had to somehow motivate service providers to buy into his system.

He decided that his system had to allow service providers to advertise their services to customers at a nominal cost. That in exchange for allowing the service providers to advertise on the website system, the service providers had to sign an agreement with the website system allowing disputes between customers and service providers to be arbitrated using the website systems arbitration mechanism and that they waive any right to dispute issues, directly relating to services contracted for, through any Governmental Administrative Body or any Judicial Court System.

At the same time, he had to ensure that payment was guaranteed to the service providers, for there too could be unscrupulous customers. He foresaw that some customers might order work through the system and after the work being satisfactorily completed, thereby claim that the work was unsatisfactory. He had to device a system that would reward the scrupulous customer and punish the unscrupulous.

He decided that customers contracting service providers through his system would have to deposit complete payment for the services contracted for within the website system, thereby guaranteeing payment to the service providers upon satisfactory completion of any job contracted for. Customers would also sign an agreement with the website system stating that disputes between customers and service providers would only be arbitrated using the website system's arbitration mechanism and that they waive the right to dispute issues, directly related to the services contracted for, through any Governmental Administrative Body or any Judicial Court System.

Payments made to the website system would be held in escrow until the service providers satisfactorily completed jobs. If jobs were satisfactorily completed, then customers would authorize the release of money to the service providers. If jobs were not satisfactorily completed, then the issue of satisfactorily completion would be decided using the website system's arbitration mechanism. Depending on the arbitration decision made, the money would be distributed to the parties.

An object of the present invention is to provide a website system that guarantees payment to service providers upon satisfactory completion of any work contracted for.

Another object of the present invention is to provide customers with a website system that will allow them to select a service provider that will guarantee satisfactory completion of any service contracted for.

A further object of the present invention is to provide service providers a medium to advertise their services cheaply.

Yet a further object of the present invention is to provide customers and service providers a private venue to arbitrate disputes arising from services contracted for.

Still a further object of the present invention is to allow customers and service providers a manner of balancing the equities if an issue arises concerning the satisfactory completion of any job contracted for.

For the foregoing reasons, there is a need for a website system that allows customers and service providers to enter into secured service agreements, wherein disputes are resolved by the website system without having to resort to the courts, attorneys, or private mediation or arbitration services.

### SUMMARY

The present invention is directed to a website system that allows customers and service providers to enter into secured service agreements, wherein disputes are resolved by the website system without having to resort to the courts, attorneys, or private mediation or arbitration services. The interactive computer-implemented website system for allowing customers to guarantee payment to service providers after services have been satisfactorily rendered comprises a website, the website includes a browsable catalogue of service providers that allows customers to electronically contract a specific service provider, order a specific type of service from the service provider, dispute the satisfactory completion of a specific service, and pay for the specific service, payments are held in escrow by the website system until the services contracted for are satisfactorily completed. An interface, the interface allows either a customer computer or a service provider computer to connect to the website system, connected to the website. A service provider database manager, the database manager stores data of service providers who allow payment of their services to be held in the website system's escrow account until the services they have been contracted for are satisfactorily completed, connected to the website. A customer database manager, the customer database manager allows customers to procure unique identifiers that allows them to securely deposit money within the website system after they enter into a service contracts with specific service providers, connected to the website. And, an arbitrator database manager, the arbitrator database manager stores data of arbitrators that can arbitrate disputes between customers and service providers, connected to the website.

### DRAWINGS

These and other features, aspects, and advantages of the present invention will become better understood with regard to the following description, appended claims, and drawings where:

FIG. 1 shows a flowchart of the present invention; and

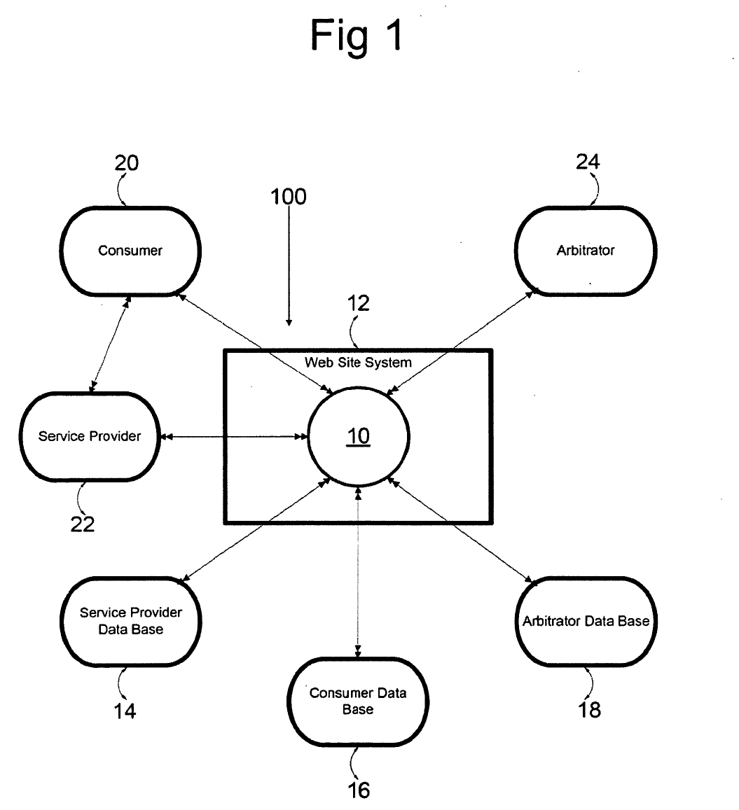

FIG. 2 shows another flowchart of the present invention.

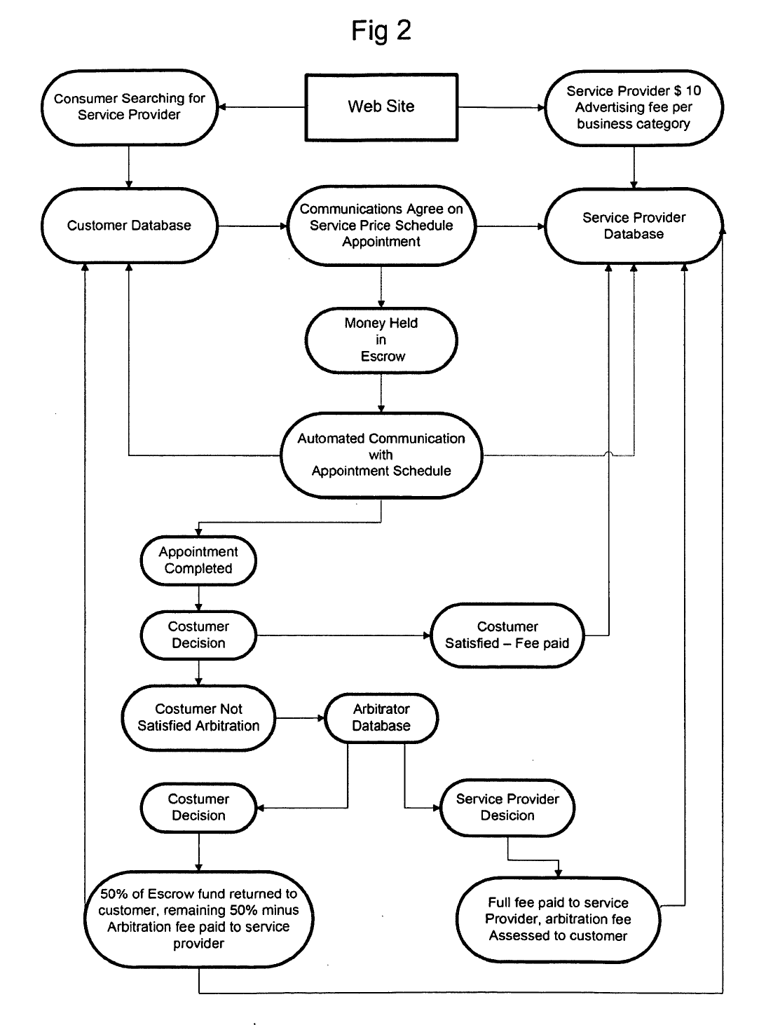

### DESCRIPTION

As seen in flowcharts 1-2, an interactive computer-implemented website system 100 for allowing customers to guarantee payment to service providers after services have been satisfactorily rendered, comprising a website 10, an interface 12 connected to the website, a service provider database manager 14 connected to the website 10, a customer database manager 16 connected to the website 10, and an arbitrator database manager 18 connected to the website 10.

The website 10 includes a browsable catalogue of service providers that allows customers 20 to electronically contract a specific service provider 22, order a specific type of service from the service provider 22, dispute the satisfactory completion of a specific service, and pay for the specific service. Payments are held in an escrow by the website system 100 until the services contracted for are satisfactorily completed.

The interface 12 allows either a customer computer 20 or a service provider computer 22 to connect to the website system 100.

The service provider database manager 14 stores data of service providers who allow payment of their services to be held in the website system's escrow account until the services they have been contracted for are satisfactorily completed.

The customer database manager 16 allows customers to procure unique identifiers that allows them to securely deposit money within the website system 100 after they enter into a service contracts with specific service providers.

The arbitrator database manager 18 stores data of arbitrators that can arbitrate disputes between customers and service providers.

In an embodiment of the interactive computer-implemented website system for allowing customers to guarantee payment to service providers after services have been satisfactorily rendered, the computer of the customer or of the service provider might be a smart phone.

A method of using the interactive computer-implemented website system 100 for allowing customers to guarantee payment to service providers after services have been satisfactorily rendered described above, comprises the steps of first receiving, from a computer of a customer 20, a command informing the system 100 that a contract has been entered with a specific service provider and a money transfer for the benefit of a specific service provider upon the satisfactory completion of the service contracted for. Then, receiving, from a computer of the specific service provider 22, a message that the service contracted for has been completed. Next, transmitting, to the computer of the customer 20, a request for release of payment if the service contracted for is satisfactory, if the service is not satisfactory then a request to schedule binding arbitration regarding payment for the service. Then, receiving, from the computer of the customer 20, the request whether or not to make payment to the service provider or to schedule binding arbitration. And lastly, if the computer of the customer 20 requests that payment be made to service provider, then making payment to service provider, if computer of the customer 20 requests binding arbitration, then selecting a specific arbitrator to arbitrate dispute.

If the consumer requested binding arbitration, then the method further comprises the steps of transmitting to a computer of the specific arbitrator 24 an instruction to schedule an arbitration between customer and the specific service provider, to arbitrate the dispute, and then to transmit the resolution of the dispute to the website system 100. Then, receiving from the specific arbitrator the resolution of the dispute. And lastly, transferring the money held in escrow in accordance with the resolution reached.

As a deterrent to having a customer file a sham request for arbitration, the party that loses the arbitration shall be made to pay for all costs relating to the arbitration.

As an incentive to having jobs completed satisfactorily, if the customer wins in arbitration, the customer shall be refunded from at least ten percent to at most fifty percent of the money held in escrow, the remaining balance shall be paid to the service provider if the arbitrator deems the job to have been completed, yet not completed satisfactorily.

It is foreseen that the specific service providers shall pay a fee to advertise on the website system.

It is further foreseen that the customers who elect to have the website system transact business between the customers and the service providers shall pay a predetermined fee to the website system.

Although the present invention has been described in considerable detail with reference to certain preferred versions thereof, other versions are possible. Therefore the spirit and the scope of the claims should not be limited to the description of the preferred versions contained herein.

What is claimed is:

1. An interactive, computer-implemented website system for allowing customers to guarantee payment to service providers after services have been satisfactorily rendered comprising:
a website, wherein the website includes a browsable catalogue of service providers that allows customers to electronically contract a specific service provider, order a specific type of service from the service provider, dispute the satisfactory completion of a specific service, and pay for the specific service, whereby payments are held in an escrow by the website system until the services contracted for are satisfactorily completed;
an interface, the interface allows either a customer computer or a service provider computer to connect to the website system, connected to the website;
a service provider database manager, the database manager stores data of service providers who allow payment of their services to be held in the website system's escrow account until the services they have been contracted for are satisfactorily completed, connected to the website;
a customer database manager, the customer database manager allows customers to procure unique identifiers that allows them to securely deposit money within the website system after they enter into a service contracts with specific service providers, connected to the website; and
an arbitrator database manager, the arbitrator database manager stores data of arbitrators that can arbitrate disputes between customers and service providers, connected to the website.

2. The interactive, computer-implemented website system for allowing customers to guarantee payment to service providers after services have been satisfactorily rendered of claim 1, wherein either the computer of the customer or the service provider is a smart phone.

3. A method of allowing customers to guarantee payment to service providers after services have been satisfactorily rendered, the method comprising:
providing a website system that includes a website having a browsable catalogue, the catalogue allows customers to electronically contract a specific service provider, order specific type of service from the specific service provider, and pay for the specific service ordered from the specific service providers, payment for service are held in an escrow account belonging to the website system until the service contracted for is satisfactorily completed;
providing a database of service providers, the database of service providers only contains service providers who allow payment of their services to be held in the website system's escrow account until the services they have been contracted for are satisfactorily completed;
providing a customer database wherein customers can procure a unique identifier that allows them to securely deposit money within the website system after entering into a service contract with a specific service provider;
providing a database of arbitrators that can arbitrate disputes between customers and service providers, arbitrators will bindingly arbitrate whether services have been satisfactorily completed, if the customers and the service providers cannot reach an amicable solution;
receiving, from a computer of a customer, a command informing the system that a contract has been entered with a specific service provider and a money transfer for the benefit of a specific service provider upon satisfactory completion of the service contracted for;
receiving, from a computer of the specific service provider, a message that the service contracted for has been completed; and
transmitting, to the computer of the customer, a request for release of payment if the service contracted for is satisfactory, if the service is not satisfactory then a request to schedule binding arbitration regarding payment for the service;
receiving, from the computer of the customer, the request whether or not to make payment to the service provider or to schedule binding arbitration; and
if the computer of the customer requests that payment be made to service provider, then making payment to service provider, if computer of the customer requests binding arbitration, then selecting a specific arbitrator to arbitrate dispute.

4. The method of claim 3, further comprising:
transmitting, to a computer of the specific arbitrator, an instruction to schedule an arbitration between customer and the specific service provider, to arbitrate the dispute, and then to transmit the resolution of the dispute to the website system;
receiving, from the specific arbitrator, the resolution of the dispute; and
transferring the money held in escrow in accordance with the resolution reached.

5. The method of claim 4, wherein either the customer or the specific service provider, whichever is deemed to be the losing party by the specific arbitrator, will pay for all costs relating to the arbitration.

6. The method of claim 5, wherein if the winning party is the customer, the customer shall be refunded from at least ten percent to at most fifty percent of the money held in escrow, the remaining balance shall be paid to the service provider if the arbitrator deems the job to have been completed, yet not completed satisfactorily.

7. The method of claim 6, wherein the specific service providers shall pay a fee to advertise on the website system.

8. The method of claim 7, wherein the customers who elect to have the website system transact business between the customers and the service providers shall pay a predetermined fee to the website system.
